(19) United States
(12) Patent Application Publication
(10) Pub. No.: US 2010/0011389 A1
(43) Pub. Date: Jan. 14, 2010

(54) SYSTEM FOR GATHERING TV AUDIENCE RATING IN REAL TIME IN INTERNET PROTOCOL TELEVISION NETWORK AND METHOD THEREOF

(76) Inventors: SangHyeun Lee, Gwangjiu-City (KR); Byung-Tak Lee, Suwon-city (KR); Ho-Young Song, Daejeon-city (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/439,677

(22) PCT Filed: Sep. 20, 2007
(86) PCT No.: PCT/KR07/04577

§ 371 Date: Mar. 2, 2009

(30) Foreign Application Priority Data
Sep. 29, 2006 (KR) 10-2006-0096497
Sep. 11, 2007 (KR) 10-2007-0092141

(51) Int. Cl. H04H 60/32

(52) U.S. Cl. 725/14; 725/109; 725/119

(57) ABSTRACT

A system for surveying audience ratings in real-time in an Internet protocol TV (IPTV) network and a method thereof are provided. The system for surveying audience ratings in real-time includes an electronic program guide (EPG) server providing channel information and audience rating survey server information to an IPTV client; the IPTV client outputting periodically reception information including channel and subscriber information, the channel being received after being selected based on the channel information; and an audience rating survey server surveying audience ratings based on the reception information. According to the system and method, the addition of any information in a broadcasting stream is not required for an audience rating survey, additional devices are not requested to be installed in the houses of viewers or listeners, and without the necessity of their cooperation, audience ratings can be automatically performed in real-time.

### CROSS-REFERENCE TO RELATED PATENT APPLICATIONS

This application claims the priority of Korean Patent Application Nos. 10-2006-0096497, filed on Sep. 29, 2006, and 10-2007-0092141, filed on Sep. 11, 2007, respectively, in the Korean Intellectual Property Office, the disclosure of which is incorporated herein in its entirety by reference.

### BACKGROUND OF THE INVENTION

1. Field of the Invention

The present invention relates to a system for surveying TV audience ratings in real-time by using the interactive characteristic of an Internet protocol TV (IPTV), and a method therefor.

2. Description of the Related Art

Hereinafter, a system in which radio or TV programs are transmitted by using a multicast or unicast method will be referred to as an “Internet protocol TV (IPTV)”.

Among audience rating surveying methods used in terrestrial broadcasting, cable broadcasting, and satellite broadcasting, there are diary type surveys in which questionnaires are distributed and people are requested to fill in the questionnaires, interview surveys by interviewers visiting or calling interviewees, meter surveys in which machines automatically record the ratings, and surveys using a People Meter.

The surveying method using the People Meter is performed with a predetermined number of households selected according to a standard sampling method as in the meter surveying method. A device called a People Meter is installed in the TV in each household, and a remote controller type mechanical device is checked by a user's intervention. The People Meter method is currently the most widely used audience rating survey method around the world.

For the audience rating survey method using the People Meter, the People Meter devices are installed in the standard sampling panelist households and the survey is performed with the cooperation of the participants. However, the method has a drawback in terms of inaccuracy due to the limited number of the sampling panelist households, and cannot be performed in real-time. In addition, in the case of TV contents, TV contents are viewed by means of terrestrial broadcasting, cable broadcasting, or satellite broadcasting and then, if viewing channel information is collected, the viewing channel information should be transmitted through a separate dedicated modem or Internet lines, thereby making the method inefficient. In addition, due to the characteristics of this audience rating survey method, this method incurs large costs.

Though the People Meter method is somewhat accurate compared to other methods, installation of the People Meter devices is complicated and costly, and the method essentially requires continuous and devoted cooperation of panelists. Furthermore, with respect to the distribution of panelists and panel survey methods, the resultant audience ratings vary greatly.

### SUMMARY OF THE INVENTION

The present invention provides a system and method capable of surveying audience ratings in real-time in which an Internet protocol TV (IPTV) to which an interactive characteristic is added is used, and thus installation of additional devices in panelist households and the intervention of users are not required, thereby removing a limitation in the number of panelist households that can be sampled, and also allowing a real-time audience rating survey with respect to whole households watching IPTVs.

According to an aspect of the present invention, there is provided a system for surveying audience ratings in real-time in an Internet protocol TV (IPTV) network, the system including: an electronic program guide (EPG) server providing channel information and audience rating survey server information to an IPTV client; the IPTV client periodically outputting reception information including channel and subscriber information, the channel being received after being selected based on the channel information; and an audience rating survey server surveying audience ratings based on the reception information.

According to another aspect of the present invention, there is provided a method of surveying audience ratings in real-time in an IPTV network, the method including: an EPG server providing channel information and audience rating survey server information to an IPTV client; the IPTV client receiving the channel information and the audience rating survey server information, selecting a channel, and generating and outputting the selected channel information and user information; and the audience rating survey server receiving the channel information and the user information output from the IPTV client, and then, processing the information, thereby generating audience rating data, and providing the audience rating data.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram illustrating a configuration of a system for viewing a conventional Internet protocol TV (IPTV);

FIG. 2 is a diagram illustrating a structure of a system for surveying audience ratings in real-time in an IPTV network according to an embodiment of the present invention;

FIG. 3 is a diagram illustrating the flow of channel information according to an embodiment of the present invention;

FIG. 4 is a diagram illustrating a process of recording viewing channel information transmitted by a client, calculating audience ratings, and monitoring audience ratings in real-time according to an embodiment of the present invention;

FIG. 5 is a diagram illustrating the flow of information in which information by audience rating survey servers disposed in each area is transferred to a central audience rating survey server according to an embodiment of the present invention; and

FIG. 6 is a diagram illustrating an example of channel information complying with an IPTV transmission method according to an embodiment of the present invention.

### DETAILED DESCRIPTION OF THE INVENTION

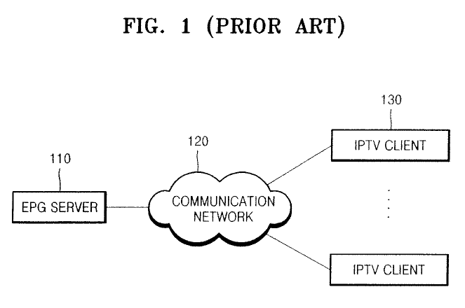

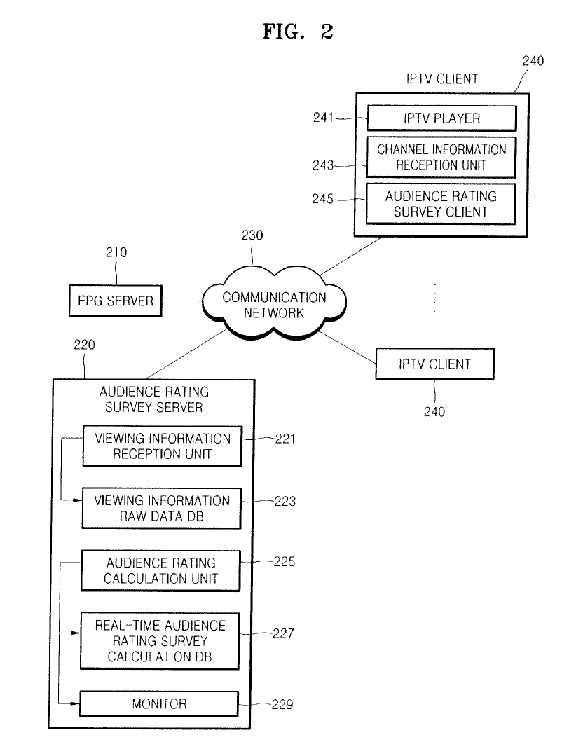

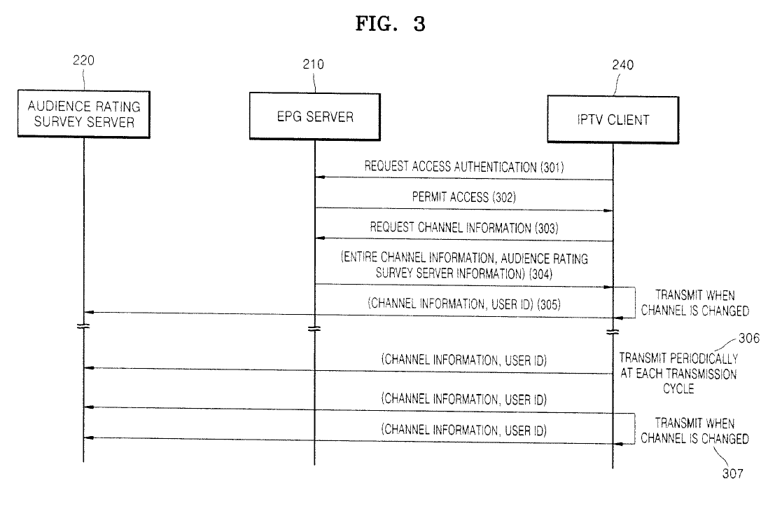

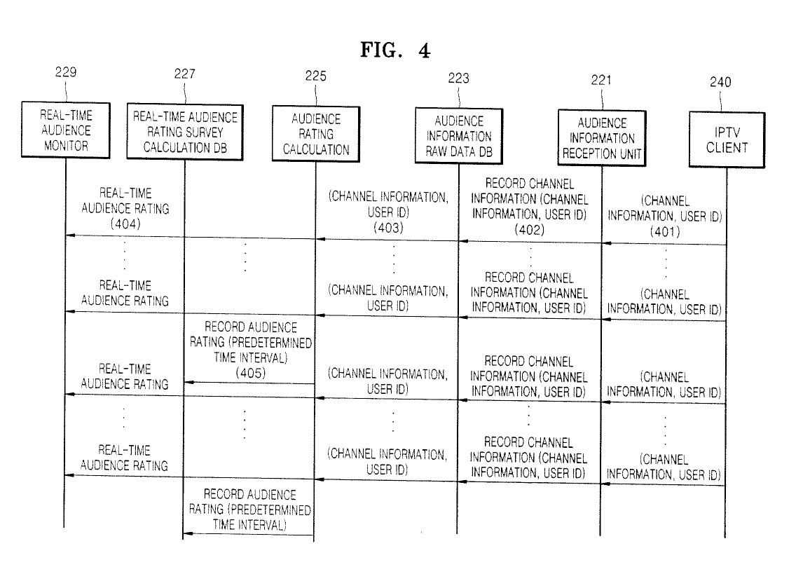

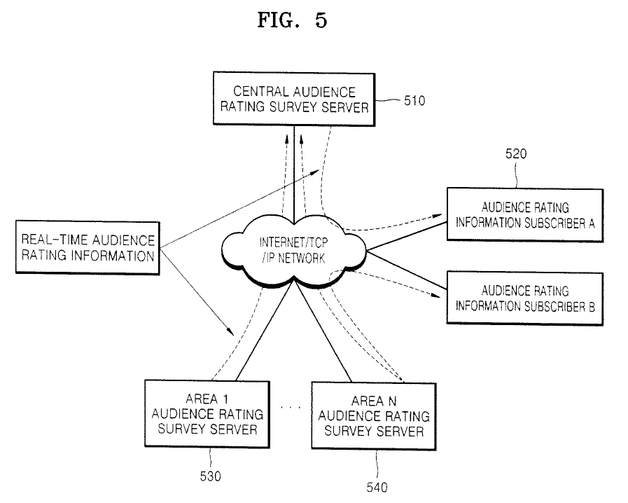

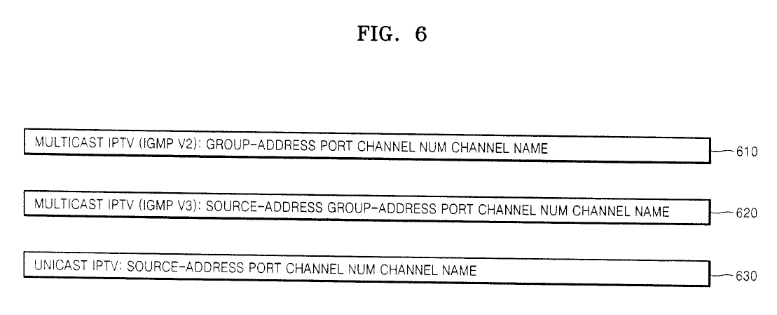

The present invention will now be described more fully with reference to the accompanying drawings, in which exemplary embodiments of the invention are shown. FIG. 1 is a schematic diagram illustrating a configuration of a system for viewing a conventional Internet protocol TV (IPTV). FIG. 2 is a diagram illustrating a structure of a system for surveying audience ratings in real-time in an IPTV network according to an embodiment of the present invention. FIG. 3 is a diagram illustrating the flow of channel information according to an embodiment of the present invention. FIG. 4 is a diagram illustrating a process of recording viewing channel information transmitted by a client, calculating audience ratings, and monitoring audience ratings in real-time according to an embodiment of the present invention. FIG. 5 is a diagram illustrating the flow of information in which information by audience rating survey servers disposed in each area is transferred to a central audience rating survey server according to an embodiment of the present invention. Finally, FIG. 6 is a diagram illustrating an example of channel information complying with an IPTV transmission method according to an embodiment of the present invention.

First, the basic idea of the present invention will now be explained.

In order to implement a method of surveying audience ratings in real-time according to an embodiment of the present invention, an additional system and method for surveying audience ratings in real-time are added to conventional systems forming an IPTV.

According to the method, channel information and audience rating survey server information from an electronic program guide (EPG) are received. When a user changes a channel, if the changed channel is fixed, the information on the channel being viewed is transmitted to an audience rating survey server for each predetermined time interval, and if the channel is changed, information on the changed channel is immediately transmitted. Also, when an audience rating survey is performed, the intervention of users is not necessary, and thereby the privacy of users is not infringed upon. In order to ensure this, viewing channel information transmitted to the audience rating survey server includes only channel information and a user identification (ID).

This viewing channel information can be referred to as raw data, and is stored in a database (DB) without processing. This raw data is data that can be submitted according to a legal procedure for the purposes of fairness of audience rating surveys and auditing of the accuracy. At this time, subscriber information of the EPG server that matches the user ID can be submitted together. The subscriber information is user information which is input into a subscription procedure when corresponding EPG services are desired to be used. The subscriber information includes a user ID, a password, an address, family members, ages, and the like.

FIG. 1 is a schematic diagram illustrating a configuration of a system for viewing a conventional IPTV. An IPTV client 130 accesses an EPG server 110 through a communication network 120, goes through an authentication procedure, and then receives channel information.

FIG. 2 is a diagram illustrating a structure of a system for surveying audience ratings in real-time in an IPTV network according to an embodiment of the present invention, and FIG. 3 is a diagram illustrating the flow of channel information according to an embodiment of the present invention. For convenience of explanation, the apparatus and method according to the current embodiments will now be explained together.

An IPTV client 240 is composed of a channel information reception unit 243 receiving channel information, an IPTV player 241 reproducing broadcasting data received through a channel that is selected based on the channel information, and an audience rating survey client 245 performing operations for an audience rating survey, which will be explained below. The IPTV client 240 accesses an EPG server 210 and an audience rating survey server 220 according to an embodiment of the present invention through a communication network 230. The audience rating survey server 220 is composed of a viewing information reception unit 221 receiving viewing information transmitted by the IPTV client 240, a viewing information raw data database (DB) 223 storing the viewing information as raw data, an audience rating calculating unit 225 calculating audience ratings based on the viewing information of each IPTV client 240, a real-time audience rating survey calculation DB 227 integrating the calculated audience ratings and storing audience rating data in real-time, and a monitor 229 displaying the final result.

The method of surveying audience ratings according to the current embodiment will now be explained according to this configuration of the system. First, the IPTV client 240 requests the EPG server 210 to perform access authentication in operation 301, and if the EPG server 210 permits access in operation 302, the IPTV client 240 requests channel information in operation 303. In response to this, if the EPG server 210 transmits the entire channel information kept in the EPG server 210 and information on the audience rating survey server 220 in operation 304. Then, the IPTV client 240 selects a desired channel based on the information and plays the channel in the IPTV player 241. The audience rating survey client 245 transmits information 305 required for the audience rating survey, including channel information on the channel currently being received and played, and a user ID, to the audience rating survey server 220. The viewing information reception unit 221 receives this information and stores it in the viewing information raw data DB 223. At this time, in principle, the information is periodically transmitted during each predetermined transmission period in operation 306. If the channel is changed by a user using the IPTV, information, including the changed channel information and the user ID, is immediately transmitted in operation 307.

FIG. 4 is a diagram illustrating a process of recording viewing channel information transmitted by a client, calculating audience ratings, and monitoring audience ratings in real-time according to an embodiment of the present invention. Referring to FIG. 4, the viewing information reception unit 221 receives channel information and user IDs arriving irregularly from a plurality of IPTV clients 240 in operation 410, and stores the information as raw data, without any modification to the viewing information raw data DB 223 in operation 402. The audience rating calculation unit 225 examines this raw data with an interval of about 1 to 5 seconds in operation 403, performs calculation and statistical processing, and displays audience ratings on the monitor in real-time in operation 404. Also, during each predetermined interval, the audience rating calculation unit 225 stores results generated after the last stored data, in the real-time audience rating survey calculation DB 227 as real-time audience rating survey data in operation 405. At this time, the time interval for storing the real-time audience rating survey data may be changed when necessary. In the process illustrated in FIG. 4, audience ratings are calculated based on the channel information transmitted by the IPTV client 240, and when the user finishes the operation of the IPTV client 240, the channel information is not received, thereby automatically removing the household from the calculation of audience ratings.

FIG. 5 is a diagram illustrating the flow of information in which information by audience rating survey servers disposed in each area is transferred to a central audience rating survey server according to an embodiment of the present invention. This is because the system illustrated in FIG. 2 may be dispersed in different areas. The audience rating information calculated in the central audience rating survey server 510 can be transmitted to an audience rating information subscriber 520. Also, audience rating information with respect to only a predetermined area may be transmitted to an audience rating subscriber who is only interested in the audience ratings of the predetermined area.

FIG. 6 is a diagram illustrating an example of channel information described above, and shows a case 610 when multicast IPTV channel information is Internet group multicast protocol (IGMP) v2 information, a case 620 when multicast IPTV channel information is IGMP v3 information, and a case 630 when the channel information is unicast IPTV information. Here, channel names are the names of broadcasting stations, such as Munhwa Broadcasting Corporation (MBC), Korean Broadcasting System (KBS) 1, KBS2, Educational Broadcasting System (EBS), and Orion Cinema Network (OCN). Channel information which is sent to the audience rating survey server 220 by the IPTV client 240 is Group-Address for IGMPv2 or Group-Address or Source-Address and Group-Address for IGMPv3 when the IPTV client 240 cannot receive channel information from the EPG server 210 or the IPTV client 240 is configured not to receive channel information. For IGMPv2 and IGMPv3, Port, Channel Num and Channel Name can be optional. Since each element is well know to a one of ordinary skill in the art pertaining to the present invention, a detailed explanation of the elements will be omitted here.

According to the system and method of surveying audience ratings in real-time in an IPTV network, the addition of any information in a broadcasting stream is not required for an audience rating survey, additional devices are not requested to be installed in the houses of viewers or listeners, and without the necessity of their cooperation, audience ratings survey can be automatically performed in real-time.

In addition, whenever the channel is changed, viewing channel information can be transmitted and recorded in real-time, thereby enabling an audience rating survey of advertisement contents as well as TV broadcasting contents to be performed. With IPTV becoming more widespread, the number of broadcasting channels is rapidly increasing, and thus, it is very difficult to survey audience ratings of all these channels using the conventional survey method. However, according to the present invention, regardless of the number of channels to be surveyed for audience ratings, the audience rating survey can be efficiently performed accurately and in real-time at a low cost. Also, the method of surveying audience ratings according to the present invention can divide channel information into predetermined regions, thereby enabling different channel policies to be used in respective regions, and also enabling this information to be integrated for overall audience rating surveys.

Accordingly, by using the system and method of surveying audience ratings in real-time according to the present invention, audience ratings can be surveyed accurately in real-time at a low cost without limits in the number of sampling panelist households, and without additional audience rating survey devices or a user's intervention.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A system for surveying audience ratings in real-time in an Internet protocol TV (IPTV) network, the system comprising:
an electronic program guide (EPG) server providing channel information and audience rating survey server information to an IPTV client;
the IPTV client periodically outputting reception information including channel and subscriber information, the channel being received after being selected based on the channel information; and
an audience rating survey server surveying audience ratings based on the reception information.

2. The system of claim 1, wherein the channel information comprises information on at least one channel provided to the IPTV client, and the audience rating survey server information comprises the Internet protocol (IP) address of the server and the transmission period of the survey information for an audience rating survey.

3. The system of claim 2, wherein any one of an Internet group multicast protocol (IGMP) v2, an IGMP v3, and a unicast IPTV protocol is applied to the channel information and then the channel information is transferred.

4. The system of claim 1, wherein whenever a channel being watched is changed the IPTV client updates the reception information and outputs the updated information.

5. The system of claim 4, wherein the updated reception information is Group-Address for IGMPv2 when the IPTV client cannot receive the channel information from the EPG server or the IPTV client is configured not to receive the channel information.

6. The system of claim 4, wherein the updated reception information is either Group-Address or Source-Address/Group-Address for IGMPv3 when the IPTV client cannot receive the channel information from the EPG server or the IPTV client is configured not to receive the channel information.

7. The system of claim 1, wherein the real-time audience rating survey system in the IPTV network further comprises an integration server integrating the audience rating survey servers allocated by region, surveying the audience ratings of the entire integrated region, and providing the audience ratings.

8. The system of claim 1, wherein if an authentication by a request from the IPTV client is successful, the EPG sever provides the channel information and the audience rating survey server information.

9. The system of claim 1, wherein the audience rating survey server receives and stores the reception information, and then, based on the reception information, calculates and provides statistical values of the audience ratings for each predetermined time interval.

10. A method of surveying audience ratings in real-time in an IPTV network including an EPG server, at least one IPTV client, and an audience rating survey server, the method comprising:
providing channel information and audience rating survey server information to an IPTV client;
receiving the channel information and the audience rating survey server information, selecting a channel, and generating and outputting the selected channel information and user information; and
receiving the channel information and the user information output from the IPTV client, and then, processing the information, thereby generating audience rating data, and providing the audience rating data.

11. The method of claim 10, wherein the EPG server provides the channel information and audience rating survey server information to the IPTV client, and the audience rating survey server receives and processes the channel information and the user information output from the IPTV client.

12. The method of claim 10, wherein before the providing by the EPG server of the channel information and audience rating survey server information, the EPG server performs authentication according to an authentication request from the IPTV client, and if the authentication is successful, the EPG server provides the channel information and the audience rating survey server information to the IPTV client.

13. The method of claim 10, wherein the channel information comprises information on all channels provided to the IPTV client, and the audience rating survey server information comprises the IP address of the server and the transmission period of the survey information for an audience rating survey.

14. The method of claim 13, wherein any one of an IGMP v2, an IGMP v3, and a unicast IPTV protocol is applied to the channel information and then the channel information is transferred.

15. The method of claim 10, wherein in the selecting of the channel and the generating and outputting of the selected channel information and user information, whenever a channel being watched is changed, the reception information is updated and output.

16. The method of claim 15, wherein the updated reception information is Group-Address for IGMPv2 when the IPTV client cannot receive the channel information from the EPG server or the IPTV client is configured not to receive the channel information

17. The method of claim 15, wherein the updated reception information is either Group-Address or Source-Address/Group-Address for IGMPv3 when the IPTV client cannot receive the channel information from the EPG server or the IPTV client is configured not to receive the channel information.

18. The method of claim 10, wherein the receiving of the channel information and the user information output from the IPTV client, and then, the processing of the information, thereby generating audience rating data, and providing the audience rating data, further comprises integrating the audience rating survey servers allocated by region, surveying the audience ratings of the entire integrated region, and providing the audience ratings.
